(19) United States
(12) Patent Application Publication
(10) Pub. No.: US 2011/0084815 A1
(43) Pub. Date: Apr. 14, 2011

(54) DEVICE AND METHOD FOR ACTIVATING A COMMUNICATION UNIT

(75) Inventor: Frank Hanns Paul Fitzek, Aalborg (DK)

(73) Assignee: AALBORG UNIVERSITET, Aalborg Ø (DK)

(21) Appl. No.: 12/933,068

(22) PCT Filed: Mar. 26, 2009
(86) PCT No.: PCT/DK09/50070

§ 371 Date: Dec. 20, 2010

(30) Foreign Application Priority Data
Mar. 26, 2008 (DK) PA 2008 00440

(51) Int. Cl. H04Q 5/22

(52) U.S. Cl. 340/10.33

(57) ABSTRACT

A communication system with a plurality of devices with a communication unit (CU1) arranged to communicate on a first wireless communication channel (CH1), e.g. GSM, in an active mode. Otherwise, the communication unit (CU1) is in an in-active power saving mode. A receiver unit (R1, R2) receives a wake-up signal on a second wireless communication channel (CH2, CH3), e.g. RFID. The receiver unit (R1, R2) then switches the communication unit (CU1) into active mode. The second wireless communication channel (CH2, CH3) is dedicated for wake-up signals and is in a different frequency band than the first wireless communication channel (CH1). Further, the first wireless communication channel (CH1) has a larger distance range than the second wireless communication channel (CH2, CH3). A coordinator device (CD) receives a call on the first wireless communication channel (GSM) and transmits a wake-up signal on the second wireless communication channel (RFID) in order to activate communication units (D1, D2, D3, D4) in a group of the plurality of devices (D1, D2, D3, D4). Hereby power can be saved to the typically more power demanding communication unit (CU1) arranged for long distance communication, while only limited or even zero power is used to monitor for wake-up signals on a short range channel (CH2, CH3). The system is suitable for groups of a plurality of rather closely spaced devices (D1, D2, D3, D4), where one active coordinator device (CD) is used to receive incoming calls on behalf of a group of devices (D1, D2, D3, D4) having their communication units in power saving mode until the coordinator device (CD) activates them.

### FIELD OF THE INVENTION

The present invention relates to the field of communication technology, especially wireless communication technology. More specifically, the invention provides a device and a method for activating a communication unit in a communication device so as to save power when the communication unit is in idle mode.

### BACKGROUND OF THE INVENTION

Energy saving is important in battery driven mobile communication devices. Mobile communication devices typically have communication units, e.g. Radio Frequency (RF) receivers and transmitters, which can be automatically switched on and off based on a timer, so as to save power to the communication unit when not used. However, even with such timer function, the communication unit will in many applications stay in idle mode most of the time it is switched on, and thus drain the battery of the mobile device at no use. E.g. a mobile phone is often switched on for a long time without receiving any call.

US 2003/0112126 A1 discloses a remote system including a Radio Frequency Identification (RFID) tag specifically identified by an RFID signal. The specific RFID tag is associated with a particular remote data transfer device. When identified, the specific RFID tag changes the state of the associated remote data transfer device from a zero power state to an operational state, i.e. the RFID tag performs a wake-up of the data transfer device. Limited power-capacity of a remote power supply is used solely for data transfer between the data transfer device and an administrator. The RF data transfer and the RFID wake-up signal may be performed at different frequencies, but within the same distance range. In this way one communication entity can wake-up another communication entity.

### SUMMARY OF THE INVENTION

Thus, according to the above description, it is an object of the present invention to provide a device, system and method of saving power e.g. in battery driven wireless mobile communication devices, still with an acceptable access to the devices.

In a first aspect, the invention provides a communication system including—a plurality of communication devices including
a communication unit arranged to communicate on a first wireless communication channel in an active mode, and wherein the communication unit is in an in-active power saving mode otherwise, and
a receiver unit arranged to receive a wake-up signal on a second wireless communication channel, wherein the receiver unit is operationally connected to switch the communication unit into the active mode upon receiving a wake-up signal on the second wireless communication channel, wherein the second wireless communication channel is dedicated for communication of wake-up signals and is in a different frequency band than the first wireless communication channel, and wherein the first wireless communication channel has a larger distance range than the second wireless communication channel, and

a coordinator device arranged to receive a call on the first wireless communication channel and to transmit a wake-up signal on the second wireless communication channel in order to activate communication units in a group of the plurality of devices, in response to the call on the first communication channel.

With such communication system, a device in the system is capable of saving energy in idle mode where the communication unit, e.g. a GSM unit, is not used, since a short range receiver unit with low power consumption, e.g. a completely different wireless technology than used by the first communication channel, can be used to monitor for incoming messages during idle mode. This is advantageous especially within mobile or portable battery powered devices. In case the receiver unit is a passive unit, e.g. an RFID tag, the idle power consumption can be reduced to zero, in case the communication unit is completely shut off in the in-active power saving mode. The communication unit is only switched to its active (power consuming) mode by the receiver unit, when a wake-up signal is received, e.g. indicating an incoming call to the communication unit.

The system is especially suited for use in groups of devices closely spaced, e.g. within an office etc., where one coordinator device maintains its communication unit active so as to be able to receive calls on the first wireless communication channel to a device in the group. The coordinator device is then arranged to transmit a wake-up signal on the second wireless communication channel to wake-up the device to which the call is intended. This device then activates its communication unit in response to the received wake-up signal, and the device can then receive the incoming call on the first communication channel. The same applies when a group of devices tries to get access to the same base station. In this case, the coordinator device can perform the task of accessing the base station in representation of the group of devices. At the same time, the devices in the group can be in power saving mode until woke-up by the coordinator device when access by the base station has been granted. With such scheme, an extra entity is involved in the communication to perform a short distance wake-up, compared to simple entity to entity communication.

Thus, with different use of the device according to the first aspect, the device is capable of saving power compared to traditional timer based wake-up of the communication unit, because the communication unit is only activated when required.

In the following, preferred communication device embodiments will be described.

At least parts of the communication unit may be disconnected from its power supply in the in-active power saving mode. The entire communication unit may be disconnected from its power supply in the in-active power saving mode, thus consuming zero power in idle mode.

Preferably, the communication unit is switched into the in-active power saving mode after completion of a communication on the first wireless communication channel, thus serving to minimize power consumption by immediately “falling asleep” after use of the communication unit.

The first wireless communication channel preferably has a distance range of e.g. at least 10 times a distance range of the second wireless communication channel, such as a distance range of e.g. at least 100 times a distance range of the second wireless communication channel, such as a distance range of e.g. at least 1000 times a distance range of the second wireless communication channel. E.g. the first wireless communication channel may be GSM with a distance range in the order of 100 meters, whereas the second wireless communication channel may be RFID with a distance range in the order of meters.

Preferably, the second wireless communication channel is a short range Radio Frequency communication channel, such as Bluetooth or RFID.

The receiver unit may include a passive sensor arranged to receive a Radio Frequency wake-up signal. With such passive sensor, the device can have zero power consumption in the in-active mode, since neither the communication unit nor the receiver unit needs power. Especially, the passive sensor includes an RFID device tuned to passively receive a wake-up signal in a predetermined frequency range.

The second wireless communication channel may be a light communication channel, such as an infrared light communication channel. Thus, the second wireless communication channel may utilize a completely different wireless technology than the first wireless communication channel, e.g. the combination of a GSM communication unit and an infrared receiver unit for receiving infrared wake-up signals. Alternatively or additionally, the second wireless communication channel may be an acoustic communication channel, such as an ultrasound communication channel.

In some embodiments, the receiver unit includes a plurality of sensors arranged to receive wake-up signals on respective wireless communication channels, e.g. using different technologies, such as described above. Especially, the plurality of sensors are arranged to receive a wake-up signal within different distance ranges, thus the device may be able to activate and de-activate the most power saving one to be used in a given situation. E.g. an RFID tag solution may be used, in case a coordinator device is very near, and in other cases, e.g. in public areas, a WLAN receiver unit may be used solely or additionally.

The receiver unit may be arranged to switch the communication unit into the active mode upon receiving wake-up signals with a predetermined selection of sensors within a predetermined period, e.g. wherein plurality of sensors includes a plurality of Radio Frequency Identification devices tuned to passively receive wake-up signals in different frequency ranges. In such cases, it is possible to use single RFID frequencies as single bits of a code, thus allowing a wake-up signal transmitter to select to wake-up a specific device by transmitting a RFID signal with a selection of frequencies corresponding to frequencies to which RFID devices of this device are tuned. Alternatively, such coded wake-up signal can be used to activate a specific communication unit of a plurality of communication units in the device, e.g. a GSM and a WLAN unit.

In one embodiment, the device includes a timer operationally connected to switch the communication unit into the active mode. Thus, in such embodiment, the present invention is combined with the traditional timer based power saving strategy, however the timer interval can be chosen much larger than in the traditional approach.

In some embodiments, the device includes a plurality of communication units arranged to communicate on different wireless communication channel in respective active modes, and wherein the plurality of communication units are in respective in-active power saving modes otherwise. Thus, such device can be used to communicate on different communication channels according to need, e.g. GSM and WLAN. Especially, the receiver unit may be arranged to switch selected ones of the plurality of communication units into active mode in accordance with a received wake-up call. The receiver unit may in such embodiments include a plurality of sensors, e.g. a plurality of RFID tags, arranged to receive wake-up calls on respective wireless communication channels, and wherein the receiver unit is arranged to switch one or more of the communication units into the active mode in response to wake-up calls received with one or more of the plurality of sensors within a predetermined period.

The device may include a transmitter unit arranged to generate a wake-up call to be received by an associated external communication device, thus such device can be used as a coordinator device for waking up one or more other devices in a group.

The first wireless communication channel may have a higher channel capacity than the second wireless communication channel, such as a channel capacity being at least 10 times the channel capacity of the second wireless communication channel, such as a channel capacity being at least 100 times the channel capacity of the second wireless communication channel. Thus, the first wireless communication channel will typically be used for large data transfers, while the channel used for wake-up signals can have a very limited channel capacity. The communication unit may be arranged to communicate on at least a communication channel in the range covered by one of: GSM, WLAN, UMTS 3G, WIMAX, and LTE.

The device may be a mobile or portable device. The device may be one of: a mobile phone, a WLAN module, a Personal Data Assistant, and a wireless sensor.

In an embodiment, the coordinator device is arranged to transmit a request for access to an external base station on the first wireless communication channel, the coordinator device further being arranged to transmit a wake-up signal on the second wireless communication channel in order to active communication units in a group of the plurality of devices, when the external base station grants access. Thus, in such system a plurality of devices can save power while waiting for the coordinator device to gain access to an external base station on the first communication channel.

The coordinator device may be arranged to transmit individual wake-up signals to wake-up individual devices of the group of the plurality of devices. Alternatively, all devices in the group are woke-up by the wake-up signal.

The coordinator device may be arranged to transmit a Radio Frequency Identification signal including a plurality of frequencies so as to wake-up an individual device of the group of the plurality of devices.

It is appreciated that the same advantages and embodiments mentioned for the first aspect apply as well for second aspect.

In a third aspect, the invention provides a method for activating a communication unit in a communication device being part of a communication system including a plurality of communication devices, the communication unit being arranged for communication on a first wireless communication channel, the method including
receiving a call on the first wireless communication channel (GSM) by a coordinator device,
transmitting from the coordinator device a wake-up signal on a second wireless communication channel dedicated for wake-up signals,—receiving the wake-up signal by a receiver unit associated with the communication device, and
activating the communication unit upon receipt of the wake-up signal, the communication unit being in an in-active power saving mode otherwise, wherein the first wireless communication channel is in a different frequency band than the second wireless communication channel, and wherein the first wireless communication channel has a larger distance range than the second wireless communication channel.

Especially, such activating method may involve three entities:
1) the communication device itself,
2) a device or a base station transmitting a request for access to the communication device on the first wireless communication channel, and
3) the coordinator device, receiving the request for access to the communication device on the first wireless communication channel and wakes up the communication device by transmitting a wake-up signal to the communication device on the second wireless communication channel. Hereby, the communication unit in the communication device becomes active, and it is able to establish a communication on the first wireless communication channel in response to the request via the coordinator device acting as a local wake-up device.

It is appreciated that the described embodiments can be intermixed in any way between all the mentioned aspects.

### BRIEF DESCRIPTION OF THE FIGURES

The invention will now be described in more detail with regard to the accompanying figures of which

FIG. 1 illustrates a diagram of a communication device embodiment, and

FIG. 2 illustrates a diagram of communication system embodiment.

The figures illustrate specific ways of implementing the present invention and are not to be construed as being limiting to other possible embodiments falling within the scope of the attached claim set.

### DETAILED DESCRIPTION OF EMBODIMENTS

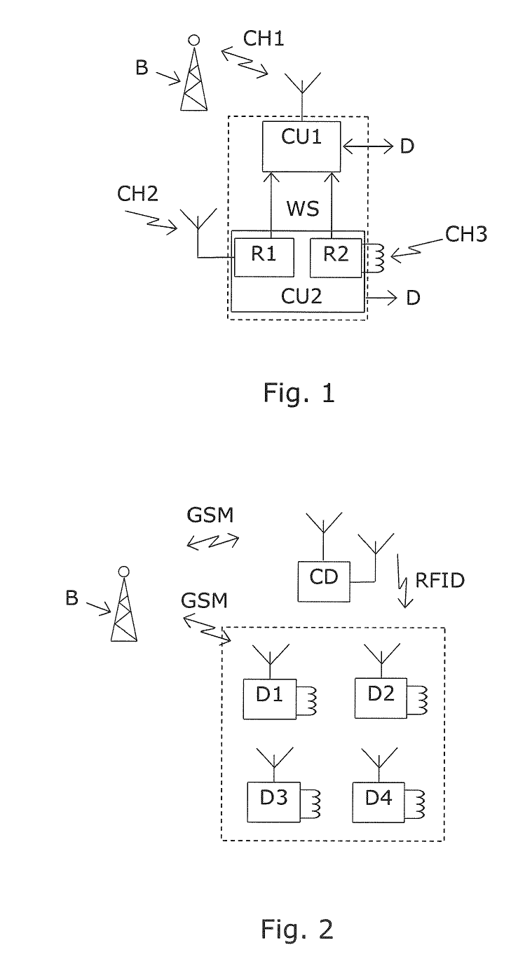

FIG. 1 shows an embodiment of a device according to the first aspect of the invention. The device includes a first communication unit CU1 arranged to two-way communicate with an external base station B, e.g. at a distance of several 100 meters, on a first wireless communication channel CH1, e.g. GSM. The first communication unit CU1 can two-way communicate data D with the base station B. The device also includes a second communication unit CU2 including a first receiver unit R1 arranged to receive a wake-up signal on a second wireless communication channel CH2, e.g. a short range RF channel such as Bluetooth. Further, the second communication unit CU2 includes a second receiver unit R2 arranged to receive a wake-up signal on a third wireless communication channel CH3, here illustrated as coil, representing a passive RFID tag. When one of the first and second receiver units receives a wake-up signal on their respective wireless communication channels, they generate an internal wake-up signal which causes the first communication unit to switch from an in-active power saving mode to an active mode, where it can receive incoming calls on the first wireless communication channel CH1. In practice, a logical unit serves to connect the receiver units R1, R2 and the first communication unit CU1 and control the wake-up and de-activation of the first communication unit CU1. The second communication unit CU2 is also illustrated with an optional link that enables receipt of data D from the second or third wireless communication channels CH2, CH3, even though the amount of data will normally be limited, since the capacity of these channels CH2, CH3 is typically inferior to the capacity of the first channel CH1.

Below is a Table showing a non-exhaustive list of preferred combinations of first and second wireless communication channels, i.e. data channels and wake-up channels are given to illustrate the idea:

| Data communication | Wake-up |
|---|---|
| channel | channel |
| GSM | Bluetooth, RFID, WLAN, infrared light, |
| | ultrasound |
| WLAN | Bluetooth, RFID, infrared light, |
| | ultrasound |
| UMTS 3G | RFID, infrared light, ultrasound |
| WIMAX | RFID, infrared light, ultrasound |
| LTE | RFID, infrared light, ultrasound |

The combinations of first and second wireless communication channels are all characterized by considerably different distance ranges, such that the channel used for wake-up calls are short range, such as covering zones as “close” or “very close”, e.g. down to distance ranges of a few centimetres. Preferably, the combination of first and second wireless communication channels are selected such that there is a considerable distance range difference, thereby gaining the most power saving by having the short range receiver active while the long distance communication unit is in in-active mode.

FIG. 2 illustrates a diagram of a communication system according to the second aspect of the invention. A group of mobile communication devices D1, D2, D3, D4 according to the first aspect are arranged to communicate with an external base station B on the GSM net, but their GSM communication unit is switched off unless it is active in communicating. The devices D1, D2, D3, D4 include receiver units with passive RFID tags that can receive short range wake-up calls without consuming any power. A coordinator device CD can also communicate on the GSM net, and its is maintained in active mode such that it can receive incoming GSM calls to one of the devices D1, D2, D3, D4 in the group. When receiving such call, the transmits an RFID wake-up signal at a frequency corresponding to the RFID tag tuning frequency of the device to which the call is intended. The device then activates its GSM communication unit such that it can receive the incoming GSM call. After completion of the call, the GSM communication unit is immediately afterwards switched back into an in-active power saving mode. In case the devices D1, D2, D3, D4 are mobile phones, their GSM communication units can naturally also be activated, when a user of the mobile phone wants to make a call.

To sum up: the invention provides a communication system with a plurality of devices with a communication unit (CU1) arranged to communicate on a first wireless communication channel (CH1), e.g. GSM, in an active mode. Otherwise, the communication unit (CU1) is in an in-active power saving mode. A receiver unit (R1, R2) receives a wake-up signal on a second wireless communication channel (CH2, CH3), e.g. RFID. The receiver unit (R1, R2) then switches the communication unit (CU1) into active mode. The second wireless communication channel (CH2, CH3) is dedicated for wake-up signals and is in a different frequency band than the first wireless communication channel (CH1). Further, the first wireless communication channel (CH1) has a larger distance range than the second wireless communication channel (CH2, CH3). A coordinator device (CD) receives a call on the first wireless communication channel (GSM) and transmits a wake-up signal on the second wireless communication channel (RFID) in order to activate communication units (D1, D2, D3, D4) in a group of the plurality of devices (D1, D2, D3, D4). Hereby power can be saved to the typically more power demanding communication unit (CU1) arranged for long distance communication, while only limited or even zero power is used to monitor for wake-up signals on a short range channel (CH2, CH3). The system is suitable for groups of a plurality of rather closely spaced devices (D1, D2, D3, D4), where one active coordinator device (CD) is used to receive incoming calls on behalf of a group of devices (D1, D2, D3, D4) having their communication units in power saving mode until the coordinator device (CD) activates them.

Although the present invention has been described in connection with the specified embodiments, it should not be construed as being in any way limited to the presented examples. The scope of the present invention is to be interpreted in the light of the accompanying claim set. In the context of the claims, the terms “including” or “includes” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A communication system comprising:
a plurality of communication devices (D1, D2, D3, D4) that comprise:
a communication unit (CU1) arranged to communicate on a first wireless communication channel (CH1) in an active mode, and wherein the communication unit (CU1) is in an in-active power saving mode otherwise,
a receiver unit (R1, R2) arranged to receive a wake-up signal on a second wireless communication channel (CH2, CH3), wherein the receiver unit (R1, R2) is operationally connected to switch the communication unit (CU1) into the active mode upon receiving a wake-up signal on the second wireless communication channel (CH2, CH3), wherein the second wireless communication channel (CH2, CH3) is dedicated for communication of wake-up signals and is in a different frequency band than the first wireless communication channel (CH1), and wherein the first wireless communication channel (CH1) has a larger distance range than the second wireless communication channel (CH2, CH3), and
a coordinator device (CD) arranged to receive a call on the first wireless communication channel (GSM) and to transmit a wake-up signal on the second wireless communication channel (RFID) in order to activate communication units (D1, D2, D3, D4) in a group of the plurality of devices (D1, D2, D3, D4), in response to the call on the first communication channel (GSM).

2-26. (canceled)

27. The communication system according to claim 1, wherein in at least one of the plurality of communication devices, at least a part of the communication unit (CU1) is disconnected from its power supply in the in-active power saving mode.

28. The communication system according to claim 1, wherein in at least one of the plurality of communication devices, the communication unit (CU1) is switched into the in-active power saving mode after completion of a communication on the first wireless communication channel (CH1).

29. The communication system according to claim 1, wherein in at least one of the plurality of communication devices, the first wireless communication channel (CH1) has a distance range of at least 10 times a distance range of the second wireless communication channel (CH2, CH3).

30. The communication system according to claim 1, wherein in at least one of the plurality of communication devices, the second wireless communication channel (CH2, CH3) is a short range Radio Frequency communication channel.

31. The communication system according to claim 30, wherein in at least one of the plurality of communication devices, the receiver unit (R1, R2) includes a passive sensor arranged to receive a Radio Frequency wake-up signal, wherein the passive sensor includes a Radio Frequency Identification device tuned to passively receive a wake-up signal in a predetermined frequency range.

32. The communication system according to claim 1, wherein in at least one of the plurality of communication devices, the second wireless communication channel (CH2, CH3) is a light communication channel.

33. The communication system according to claim 1, wherein in at least one of the plurality of communication devices, the receiver unit (R1, R2) includes a plurality of sensors arranged to receive wake-up signals on respective wireless communication channels (CH2, CH3).

34. The communication system according to claim 33, wherein in at least one of the plurality of communication devices, the plurality of sensors are arranged to receive a wake-up signal within different distance ranges.

35. The communication system according to claim 33, wherein in at least one of the plurality of communication devices, the receiver unit (R1, R2) is arranged to switch the communication unit (CU1) into the active mode upon receiving wake-up signals with a predetermined selection of sensors within a predetermined period, wherein in at least one of the plurality of communication devices, the plurality of sensors includes a plurality of Radio Frequency Identification devices tuned to passively receive wake-up signals in different frequency ranges.

36. The communication system according to claim 1, wherein at least one of the plurality of communication devices comprises a timer operationally connected to switch the communication unit (CU1) into the active mode.

37. The communication system according to claim 1, wherein at least one of the plurality of communication devices includes a plurality of communication units arranged to communicate on different wireless communication channel in respective active modes, and wherein the plurality of communication units are in respective in-active power saving modes otherwise, wherein in at least one of the plurality of communication devices, the receiver unit is arranged to switch selected ones of the plurality of communication units into active mode in accordance with a received wake-up call.

38. The communication system according to claim 37, wherein in at least one of the plurality of communication devices, the receiver unit comprises a plurality of sensors arranged to receive wake-up calls on respective wireless communication channels, and wherein the receiver unit is arranged to switch one or more of the communication units into the active mode in response to wake-up calls received with one or more of the plurality of sensors within a predetermined period.

39. The communication system according to claim 1, wherein at least one of the plurality of communication devices comprises a transmitter unit arranged to generate a wake-up call (RFID) to be received by an associated external communication device (D1, D2, D3, D4).

40. The communication system according to claim 1, wherein in at least one of the plurality of communication devices, the first wireless communication channel (CH1) has a higher channel capacity than the second wireless communication channel (CH2, CH3), such as a channel capacity being at least 10 times the channel capacity of the second wireless communication channel (CH2, CH3), such as a channel capacity being at least 100 times the channel capacity of the second wireless communication channel (CH2, CH3).

41. The communication system according to claim 1, wherein at least one of the plurality of communication devices is selected from the group consisting of a mobile phone, a WLAN module, a Personal Data Assistant, and a wireless sensor.

42. The communication system according to claim 1, wherein the coordinator (CD) device is arranged to transmit a request for access to an external base station (B) on the first wireless communication channel (GSM), the coordinator device (CD) further being arranged to transmit a wake-up signal on the second wireless communication channel (RFID) in order to active communication units (D1, D2, D3, D4) in a group of the plurality of devices (D1, D2, D3, D4), when the external base station (B) grants access.

43. The communication system according to claim 1, wherein the coordinator device (CD) is arranged to transmit individual wake-up signals to wake-up individual devices (D1, D2, D3, D4) of the group of the plurality of devices (D1, D2, D3, D4).

44. The communication system according to claim 43, wherein the coordinator device (CD) is arranged to transmit a Radio Frequency Identification signal (RFID) including a plurality of frequencies so as to wake-up an individual device (D1, D2, D3, D4) of the group of the plurality of devices (D1, D2, D3, D4).

45. A method for activating a communication unit in a communication device being part of a communication system comprising a plurality of communication devices, the communication unit being arranged for communication on a first wireless communication channel, the method comprising:
receiving a call on the first wireless communication channel (GSM) by a coordinator device,
transmitting from the coordinator device a wake-up signal on a second wireless communication channel dedicated for wake-up signals,
receiving the wake-up signal by a receiver unit associated with the communication device, and
activating the communication unit upon receipt of the wake-up signal, the communication unit being in an in-active power saving mode otherwise,
wherein the first wireless communication channel is in a different frequency band than the second wireless communication channel, and wherein the first wireless communication channel has a larger distance range than the second wireless communication channel.
